(19) United States
(12) Patent Application Publication
(10) Pub. No.: US 2010/0133361 A1
(43) Pub. Date: Jun. 3, 2010

(54) FUEL INJECTION VALVE FOR INTERNAL COMBUSTION ENGINE

(76) Inventors: Yoshinori Futonagane, Shizuoka-ken (JP); Yoshimasa Watanabe, Shizuoka-ken (JP); Shigeo Nomura, Aichi-ken (JP); Yoshiaki Nishijima, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/595,709

(22) PCT Filed: Apr. 3, 2008
(86) PCT No.: PCT/IB2008/000799

§ 371 Date: Jan. 29, 2010

(30) Foreign Application Priority Data
Apr. 13, 2007 (JP) 2007 106052

(51) Int. Cl. F02M 61/00

(52) U.S. Cl. 239/533.12

(57) ABSTRACT

A fuel injection valve (2) includes a first injection hole group (14), a second injection hole group (15), a control chamber (20), a first needle valve (12), and a second needle valve (13). The first needle valve (12) opens/closes an injection hole in the first injection hole group (14). The second needle valve (13) opens/closes an injection hole in the second injection hole group (15). Lifting of the first needle valve (12), and lifting of the second needle valve (13) are controlled by a pressure of fuel in the control chamber (20). An automatic valve (32) is further provided to change a flow rate at which the fuel flows into the control chamber (20), or a flow rate at which the fuel flows out from the control chamber (20), based on a common-rail pressure in a fuel supply source (1), when the needle valves (12, 13) are lifted. Thus, the fuel injection valve (2) injects fuel at the optimum fuel injection rate in various engine operating states.

### BACKGROUND OF THE INVENTION

1. Field of the Invention

The invention relates to a fuel injection valve for an internal combustion engine.

2. Description of the Related Art

Recently, a fuel injection valve used for an internal combustion engine, which includes two injection hole groups, has been developed. In the fuel injection valve, fuel injection from only one of the injection hole groups, and fuel injection from both of the injection hole groups are selectively used. In the fuel injection valve, when the internal combustion engine is operated in a low-load state, the fuel is generally injected from only one of the injection hole groups, that is, only the group of injection holes with a small diameter. Thus, the fuel is atomized. When the internal combustion engine is operated in a high-load state, the fuel is generally injected also from the other group of the injection holes with a large diameter, as well as from the group of the injection holes with the small diameter. Thus, a large amount of fuel is injected in a short time.

Japanese Patent Application Publication. No. 2005-320904 (JP-A-2005-320904) describes a fuel injection valve that includes a cylindrical outer needle valve, and an inner needle valve. The inner needle valve is provided inside the outer needle valve to be positioned coaxially with the outer needle valve. The outer needle valve opens/closes injection holes in one of injection hole groups, and the inner needle valve opens/closes injection holes in the other injection hole group.

Particularly, in the fuel injection valve described in the publication No. 2005-320904, a control chamber is provided close to the rear ends of the outer needle valve and the inner needle valve. When the fuel flows out from the control chamber, and thus, the pressure of the fuel in the control chamber is decreased, the outer needle valve and the inner needle valve are sequentially lifted. When the fuel injection valve is operated, and the fuel flows out from the control chamber, first, the outer needle valve starts to be lifted, and thus, the fuel is injected from only the injection holes in one of the injection hole groups. After the outer needle valve is lifted to some extent, the inner needle valve starts to be lifted, and thus, the fuel is injected from the injection holes in both of the injection hole groups. However, if the fuel stops flowing out from the control chamber before the outer needle valve is lifted to some extent, the lift of the inner needle valve is not started, and accordingly, the fuel is injected from only the injection holes in one of the injection hole groups during the period from when fuel injection is started until when the fuel injection is finished.

In the fuel injection device described in the publication No. 2005-320904, the flow rate, at which the fuel flows out from the control chamber, is not changed. Thus, basically, the fuel flows out from the control chamber at a constant flow rate during the period from when the lift of the needle valve is started, until when the lift of the needle valve is finished. Therefore, if the flow rate at which the fuel flows out from the control chamber is made high, for example, by making large the opening degree of an orifice provided in a passage through which the fuel flows out from the control chamber (for example, by making large the diameter of the orifice), an injection rate, at which the fuel is injected from the fuel injection valve, is changed in the manner shown by solid lines a and a′ in FIG. 10A. If the flow rate at which the fuel flows out from the control chamber is made low, for example, by making small the opening degree of the orifice provided in the passage through which the fuel flows out from the control chamber (for example, by making small the diameter of the orifice), the injection rate, at which the fuel is injected from the fuel injection valve, is changed in the manner shown by dashed lines b and b′ in FIG. 10A. In FIG. 10A, each of the solid line a and the dashed line b indicates the case where the fuel is injected in a long period, for example, the case where the internal combustion engine is operated in the high-load high-speed state. Each of the solid line a′ and the dashed line b′ indicates the case where the fuel is injected in a short period, for example, the case where the internal combustion engine is operated in the low-load low-speed state.

FIG. 10B shows the relation between the amount of nitrogen oxide (NOx) and the amount of smoke contained in exhaust gas discharged from the body of the internal combustion engine, in the case where the internal combustion engine is operated in the high-load high-speed state. That is, in the case where the internal combustion engine is operated in the high-load high-speed state, when the opening degree of the orifice is large (as shown by the solid line a in FIG. 10B), the amounts of generated smoke and NOx are small, as compared to when the opening degree of the orifice is small (as shown by the dashed line b in FIG. 10B). Also, as shown in FIG. 10A, when the opening degree of the orifice is large, the flow rate of the injected fuel per unit time in an initial period is high, that is, the speed at which the fuel flows out is high, and therefore, the output from the engine is increased, as compared to when the opening degree of the orifice is small. Accordingly, when the internal combustion engine is operated in the high-load high-speed state, it is preferable that the opening degree of the orifice should be made large, and the fuel should flow out from the control chamber at a high rate, to reduce the amount of pollutants in exhaust gas, and to increase the output from the engine.

FIG. 10C shows the relation between the amount of NOx and the amount of hydrocarbon (HC) contained in the exhaust gas discharged from the body of the internal combustion engine, in the case where the internal combustion engine is operated in the low-load low-speed state. That is, in the case where the internal combustion engine is operated in the low-load low-speed state, when the opening degree of the orifice is small (as shown by the dashed line b′ in FIG. 10C), the amounts of generated HC and NOx are small, as compared to when the opening degree of the orifice is large (as shown by the solid line a′ FIG. 10C). Accordingly, when the internal combustion engine is operated in the low-load low-speed state, it is preferable that the opening degree of the orifice should be made small, and the fuel should flow out from the control chamber at a low rate, to reduce the amount of pollutants in exhaust gas.

Thus, the optimum flow rate at which the fuel flows out from the control chamber varies according to an engine operating state. However, in the fuel injection valve described in the publication No. 2005-320904, the flow rate at which the fuel flows out from the control chamber cannot be changed. Accordingly, it is not possible to inject the fuel at the optimum injection rate in all the engine operating states.

### SUMMARY OF THE INVENTION

The invention relates to a fuel injection valve that injects fuel at an optimum fuel injection rate in various engine operating states.

A first aspect of the invention relates to a fuel injection valve that includes a first injection hole group, a second injection hole group, a control chamber, and a needle valve, wherein an injection hole in the first injection hole group, and an injection hole in the second injection hole group are separately opened/closed according to a lift amount of the needle valve. The fuel injection valve further includes a flow rate change device that changes a flow rate at which fuel flows into the control chamber, or a flow rate at which the fuel flows out from the control chamber. The flow rate change device changes the flow rate based on a common-rail pressure in a fuel supply source.

In the above-described fuel injection valve, the flow rate at which the fuel flows into the control chamber, or the flow rate at which the fuel flows out from the control chamber is changed based on the common-rail pressure in the fuel supply source. The common-rail pressure is changed according to an engine load and an engine speed, that is, an engine operating state. Accordingly, the flow rate at which the fuel flows into the control chamber, or the flow rate at which the fuel flows out from the control chamber is changed according to the engine operating state. Thus, the rate, at which the fuel injection rate is changed, is changed according to the engine operating state.

In the above-described fuel injection valve, the needle valve may include a first needle valve and a second needle valve; the first needle valve may open/close the injection hole in the first injection hole group, and the second needle valve may open/close the injection hole in the second injection hole; and lifting of the first needle valve and lifting of the second needle valve may be controlled by a pressure of the fuel in the control chamber.

In the above-described fuel injection valve, when the lift amount of the needle valve is equal to or smaller than a predetermined amount, only the injection hole in the first injection hole group may be opened; and when the lift amount of the needle valve is larger than the predetermined amount, the injection hole in the first injection hole group and the injection hole in the second injection hole group may be opened.

In the above-described fuel injection valve, the flow rate change device may change the flow rate so that as the common-rail pressure in the fuel supply source becomes lower, an amount of fuel in the control chamber is decreased at a lower rate.

In the above-described fuel injection valve, the flow rate change device changes the flow rate so that as the common-rail pressure in the fuel supply source becomes higher, an amount of fuel in the control chamber is decreased at a higher rate.

In the above-described fuel injection valve, the flow rate change device may include a fuel inflow passage that is communicated with the fuel supply source and the control chamber, and a flow rate control valve that adjusts a flow rate at which the fuel flows through the fuel inflow passage; when the common-rail pressure in the fuel supply source is equal to or higher than a predetermined pressure, the flow rate control valve may close the fuel inflow passage; and when the common-rail pressure is lower than the predetermined pressure, the flow rate control valve may completely open the fuel inflow passage.

In the above-described fuel injection valve, an orifice may be provided in the fuel inflow passage at a position between the flow rate control valve and the control chamber.

In the above-described fuel injection valve, an orifice may be provided in a fuel outflow passage through which the fuel flows from the control chamber to a fuel recovery portion.

In the above-described fuel injection valve, the flow rate change device may change the flow rate so that in an early part of a period in which the needle valve is lifted, an amount of fuel in the control chamber is decreased at a lower rate than a rate at which the amount of fuel in the control chamber is decreased in a late part of the period in which the needle valve is lifted.

In the above-described fuel injection valve, the flow rate change device may include a fuel inflow passage that is communicated with the fuel supply source and the control chamber, and a flow rate control valve that adjusts a flow rate at which the fuel flows through the fuel inflow passage; the flow rate control valve may close the fuel inflow passage in the early part of the period in which the needle valve is lifted; and the flow rate control valve may completely open the fuel inflow passage in the late part of the period in which the needle valve is lifted.

In the above-described fuel injection valve, the flow rate change device may include a fuel outflow passage that is communicated with a fuel recovery portion and the control chamber, and a flow rate control valve that adjusts a flow rate at which the fuel flows through the fuel outflow passage; the flow rate control valve may close the fuel outflow passage in the early part of the period in which the needle valve is lifted; and the flow rate control valve may completely, open the fuel outflow passage in the late part of the period in which the needle valve is lifted.

In the above-described fuel injection valve, in the flow rate control valve, a piston may be housed in a cylinder to slide in the cylinder; a first surface of the piston may be communicated with the fuel supply source via an upstream fuel inflow passage; a second surface of the piston, which is opposite to the first surface, may be communicated with the control chamber via a fuel passage for the flow rate control valve; and a passage may be provided in the piston to connect a downstream fuel inflow passage that is communicated with the flow rate control valve, to the first surface.

According to the invention, the rate, at which the fuel injection rate is changed, is changed according to the engine operating state. Therefore, the fuel is injected at the optimum fuel injection rate in various engine operating states.

### BRIEF DESCRIPTION OF THE DRAWINGS

The features, advantages, and technical and industrial significance of this invention will be better understood by reading the following detailed description of embodiments of the invention, when considered in connection with the accompanying drawings, in which:

FIG. 1 is a schematic cross sectional view showing a fuel injection valve according to a first embodiment of the invention;

FIG. 2 is an enlarged view showing the fuel injection valve shown in FIG. 1;

FIG. 3A is a diagram showing the relation between an engine load/an engine speed and a common-rail pressure;

FIG. 3B and FIG. 3C are diagrams showing changes in an injection rate;

FIG. 4 is a schematic cross sectional view showing a fuel injection valve according to a modified example of the first embodiment of the invention;

FIG. 5A is a schematic cross sectional view showing a fuel injection valve according to a second embodiment of the invention;

FIG. 5B is a schematic cross sectional view showing a fuel injection valve according to a modified example of the second embodiment of the invention;

FIG. 6A is a diagram showing a change in the injection rate during a period from when fuel injection from the fuel injection valve is started, until when the fuel injection is finished;

FIG. 6B is a diagram showing a change in the injection rate during the period from when fuel injection from a fuel injection valve is started, until when the fuel injection is finished, in the case where the opening degree of an orifice is large;

FIG. 6C is a diagram showing a change in the injection rate during a period from when fuel injection from the fuel injection valve is started, until when the fuel injection is finished, in the case where the opening degree of the orifice is small;

FIG. 7A is a schematic cross sectional view showing a fuel injection valve according to a third embodiment of the invention;

FIG. 7B is a schematic cross sectional view showing a fuel injection valve according to a modified example of the third embodiment of the invention;

FIGS. 8A, 8B, and 8C are diagrams that show an example of an automatic valve, and that show that a piston is placed at different positions;

FIG. 9 is a diagram showing another example of the automatic valve;

FIG. 10A is a diagram showing a change in an injection rate at which fuel is injected from a conventional fuel injection valve;

FIG. 10B is a diagram showing the relation between the amounts of NOx and smoke in the case where an internal combustion engine is operated in a high-load high-speed state; and

FIG. 10C is a diagram showing the relation between the amounts of NOx and HC in the case where the internal combustion engine is operated in a low-load low-speed state.

### DETAILED DESCRIPTION OF EMBODIMENTS

In the following description and the accompanying drawings, the present invention will be described in more detail with reference to embodiments.

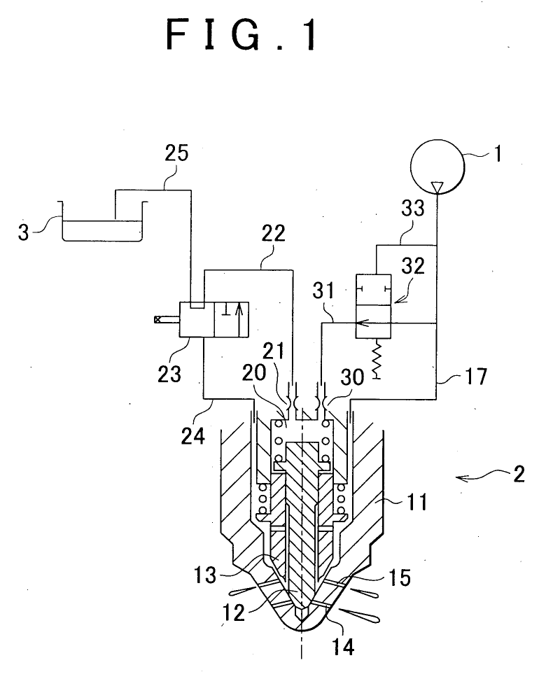

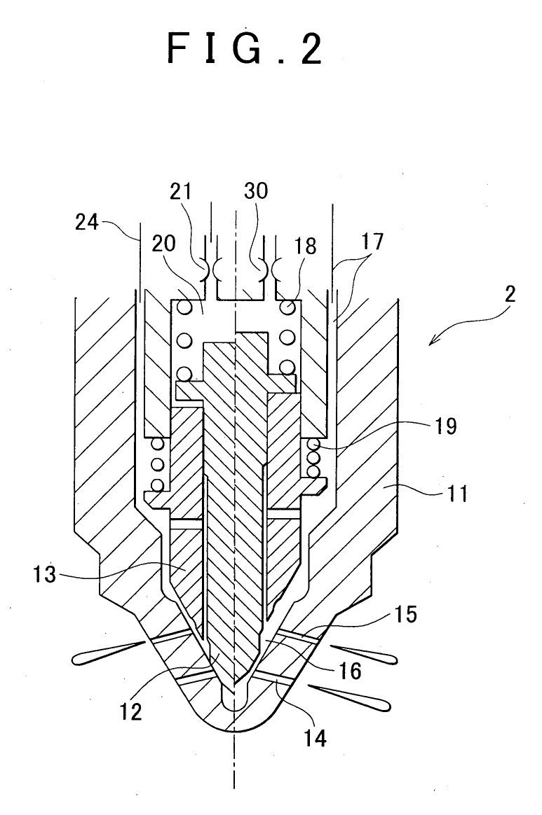

Hereinafter, embodiments of the invention will be described in detail with reference to the drawings. FIG. 1 is a schematic cross sectional view showing a fuel injection valve according to a first embodiment of the invention. FIG. 2 is an enlarged view showing the fuel injection valve shown in FIG. 1. The left part of FIG. 2 shows the fuel injection valve in which only an outer needle valve is lifted. The right part of FIG. 2 shows the fuel injection valve in which both of the outer needle valve and an inner needle valve are lifted.

A fuel injection device according to the embodiment includes a common rail (fuel pressure accumulation portion) 1, a fuel injection valve (hereinafter, the fuel injection valve will be sometimes referred to as “injector”) 2, and a fuel tank (fuel recovery portion) 3. High-pressure fuel is supplied from the fuel tank 3 to the common rail 1 using a high-pressure pump. The high-pressure fuel is supplied from the common rail to the injector 2. The injector 2 injects the fuel to an engine combustion chamber (not shown). The fuel to be injected is stored in the fuel tank 3. The pressure of the fuel in the common rail 1 is maintained at a relatively high pressure (for example, 80 MPa to 140 MPa).

As shown in FIG. 2, the injector 2 includes a cylindrical nozzle body 11, the inner needle valve 12, and the outer needle valve 13. The inner needle valve 12 is solid, and disposed coaxially with the nozzle body 11. The outer needle valve 13 is hollow, and disposed coaxially with the nozzle body 11. The nozzle body 11 is hollow, that is, the nozzle body 11 includes an inner space. Both of the needle valves 12 and 13 are housed in the inner space. The outer needle valve 13 includes an inner space. The inner needle valve 12 is housed in the inner space of the outer needle valve 13. Two injection hole groups, that is, an inner injection hole group 14 and an outer injection hole group 15 are formed in the end portion of the nozzle body 11. Each of the inner injection hole group 14 and the outer injection hole group 15 includes one or more injection holes. The injection holes in the inner injection hole group 14 are opened/closed by the inner needle valve 12. The injection holes in the outer injection hole group 15 are opened/closed by the outer needle valve 13. In the specification, the portion of the fuel injection device in the lower part of FIG. 1, that is, the portion of the fuel injection device, where the injection hole groups 14 and 15 are formed in the nozzle body 11, is regarded as the lower portion of the fuel injection device. The portion of the fuel injection device in the upper part of FIG. 1, that is, the portion of the fuel injection device, where no injection hole group is formed, is regarded as the upper portion of the fuel injection device.

A nozzle chamber 16 is formed between the inner surface of the nozzle body 11 and the outer peripheral surface of the outer needle valve 13, and between the inner surface of the nozzle body 11 and the outer surface of the end portion of the inner needle valve 12. The fuel to be injected from the injector 2 flows in the nozzle chamber 16. The nozzle chamber 16 is communicated with a high-pressure fuel supply passage 17 that leads to the common rail 1. Also, the nozzle chamber 16 is communicated with the injection holes in the injection hole groups 14 and 15 formed in the end portion of the nozzle body 11.

The inner needle valve 12 and the outer needle valve 13 slide in the directions of the respective axes. When the needle valves 12 and 13 slide in the directions of the respective axes, the injection holes in the injection hole groups 14 and 15 are opened/closed. That is, when the needle valves 12 and 13 are lifted, the injection holes in the inner injection hole group 14 and the outer injection hole group 15 are communicated with the nozzle chamber 16, and the fuel is injected from the injection holes. When the needle valves 12 and 13 are in the bottom positions (i.e., the needle valves 12 and 13 are not lifted), and the end portions of the needle valves 12 and 13 are placed on a seat formed on the inner wall surface of the end portion of the nozzle body 11, the injection holes are closed, and accordingly, the injection of the fuel from the injection holes is stopped.

An inner needle spring 18 presses the inner needle valve 12 downward in the direction of the axis thereof to close the injection holes in the inner injection hole group 14. An outer needle spring 19 presses the outer needle valve 13 downward in the direction of the axis thereof to close the injection holes in the outer injection hole group 15. A pressure control chamber 20 is defined between the upper end surfaces of the needle valves 12 and 13 and the inner surface of the nozzle body 11. The fuel is supplied into the pressure control chamber 20. A downward force is applied to the inner needle valve 12 and the outer needle valve 13 due to the pressure of the fuel in the pressure control chamber 20. That is, the downward force is applied to the inner needle valve 12 and the outer needle valve 13 due to the springs 18 and 19, and the fuel in the pressure control chamber 20. Also, an upward force (i.e., the force in such a direction as to open the injection holes) is applied to the inner needle valve 12 and the outer needle valve 13 due to the pressure of the fuel in the nozzle chamber 16.

Accordingly, when the downward force (i.e., the force in such a direction as to close the injection holes), which is applied to the inner needle valve 12 due to the inner needle spring 18 and the pressure of the fuel in the pressure control chamber 20, is equal to or larger than the upward force (i.e., the force in such a direction as to open the injection holes), which is applied to the inner needle valve 12 due to the pressure of the fuel in the nozzle chamber 16, the inner needle valve 12 is moved downward, or the injection holes in the inner injection hole group 14 are kept closed. When the downward force, which is applied to the inner needle valve 12 due to the inner needle spring 18 and the pressure of the fuel in the pressure control chamber 20, is smaller than the upward force, which is applied to the inner needle valve 12 due to the pressure of the fuel in the nozzle chamber 16, the inner needle valve 12 is lifted.

Similarly, when the downward force (i.e., the force in such a direction as to close the injection holes), which is applied to the outer needle valve 13 due to the outer needle spring 19 and the pressure of the fuel in the pressure control chamber 20, is equal to or larger than the upward force (i.e., the force in such a direction as to open the injection holes), which is applied to the outer needle valve 13 due to the pressure of the fuel in the nozzle chamber 16, the outer needle valve 13 is moved downward, or the injection holes in the outer injection hole group 15 are kept closed. When the downward force, which is applied to the outer needle valve 13 due to the outer needle spring 19 and the pressure of the fuel in the pressure control chamber 20, is smaller than the upward force, which is applied to the outer needle valve 13 due to the pressure of the fuel in the nozzle chamber 16; the outer needle valve 13 is lifted. The pressing force of the outer needle spring 19 is smaller than the pressing force of the inner needle spring 18.

The pressure control chamber 20 is communicated with a fuel outflow/inflow passage 22 via an orifice 21. The fuel outflow/inflow passage 22 is connected to a control valve 23. The fuel outflow/inflow passage 22 functions as a fuel outflow passage through which the fuel flows out from the pressure control chamber 20, or as a fuel inflow passage through which the fuel flows into the pressure control chamber 20, depending on the situation. The control valve 23 is connected to a high-pressure fuel passage 24, and a return passage 25. The high-pressure fuel passage 24 is communicated with the nozzle chamber 16. The return passage 25 is connected to the fuel tank 3. The control valve 23 selectively provides communication between the fuel outflow/inflow passage 22 and the high-pressure fuel passage 24, or communication between the fuel outflow/inflow passage 22 and the return passage 25.

As shown in FIG. 1, when the control valve 23 provides communication between the fuel outflow/inflow passage 22 and the high-pressure fuel passage 24 (that is, the control valve 23 is in “a high-pressure passage connection state”), the pressure control chamber 20 is communicated with the nozzle chamber 16, and therefore, the pressure of the fuel in the pressure control chamber 20 is increased to be equal to a high fuel pressure in the common rail 1 (hereinafter, this high fuel pressure in the common rail 1 will be referred to as “common-rail pressure”). When the control valve 23 provides communication between the fuel outflow/inflow passage 22 and the return passage 25 (that is, the control valve 23 is in “a return passage connection state”), the fuel is returned from the pressure control chamber 20 to the fuel tank 3, and therefore, the pressure of the fuel in the pressure control chamber 20 is gradually decreased.

The control valve 23 is controlled by a solenoid actuator controlled by an ECU. However, means for controlling the control valve 23 is not limited to the solenoid actuator. The control valve 23 may be controlled by other actuators, such as a piezoelectric element, and a super-magnetostrictive element.

In the fuel injection valve 2 with this configuration, when the fuel needs to be injected, first, the state of the control valve 23 is switched from the high-pressure passage connection state to the return passage connection state. Thus, the fuel flows from the pressure control chamber 20 to the fuel tank 3 via the fuel outflow/inflow passage 22, the control valve 23, and the return passage 25. The flow rate at which the fuel flows out from the pressure control chamber 20 is limited to a constant flow rate by the orifice 21. Accordingly, the pressure of the fuel in the pressure control chamber 20 is gradually decreased. First, the outer needle valve 13, whose pressing force is small, starts to be lifted, and thus, the fuel starts to be injected from the injection holes in the outer injection hole group 15.

If the control valve 23 remains in the return passage connection state even after the outer needle valve 13 is lifted to some extent, the pressure of the fuel in the pressure control chamber 20 is further decreased, and thus, the inner needle valve 12 starts to be lifted, and the fuel starts to be injected also from the injection holes in the inner injection hole group 14. Then, when the state of the control valve 23 is switched from the return passage connection state to the high-pressure passage connection state, the pressure of the fuel in the pressure control chamber 20 is gradually increased, and both of the inner needle valve 12 and the outer needle valve 13 are moved downward. Accordingly, the injection holes in the inner injection hole group 14 are closed first, and then, the injection holes in the outer injection hole group 15 are closed. Thus, the fuel injection is finished.

If the state of the control valve 23 is switched from the return passage connection state to the high-pressure passage connection state before the outer needle valve 13 is lifted to some extent, the fuel flows into the pressure control chamber 20. Accordingly, the pressure of the fuel in the pressure control chamber 20 is gradually increased, and the outer needle valve 13 is moved downward. Thus, eventually, the injection holes in the outer injection hole group 15 are closed, and the fuel injection is finished. By controlling the control valve 23 in this manner, it is possible to inject a small amount of fuel from the fuel injection valve 2.

In the fuel injection valve 2 in the embodiment, the pressure control chamber 20 is communicated with the fuel outflow/inflow passage 22 via the orifice 21, and is communicated with a fuel inflow passage 31 via an orifice 30. The fuel inflow passage 31 is communicated with the high-pressure fuel supply passage 17. An automatic valve 32 is provided in the fuel inflow passage 31. The automatic valve 32 is connected to an automatic valve drive fuel passage 33. The automatic valve drive fuel passage 33 is also communicated with the high-pressure fuel supply passage 17.

The common-rail pressure is applied to the automatic valve 32 from the automatic valve drive fuel passage 33. Thus, when the common-rail pressure is equal to or higher than a predetermined pressure, the automatic valve 32 is closed, and accordingly, the fuel does not flow into the pressure control chamber 20 via the fuel inflow passage 31. When the common-rail pressure is lower than the predetermined pressure, the automatic valve 32 is opened, and accordingly, the fuel flows into the pressure control chamber 20 via the fuel inflow passage 31.

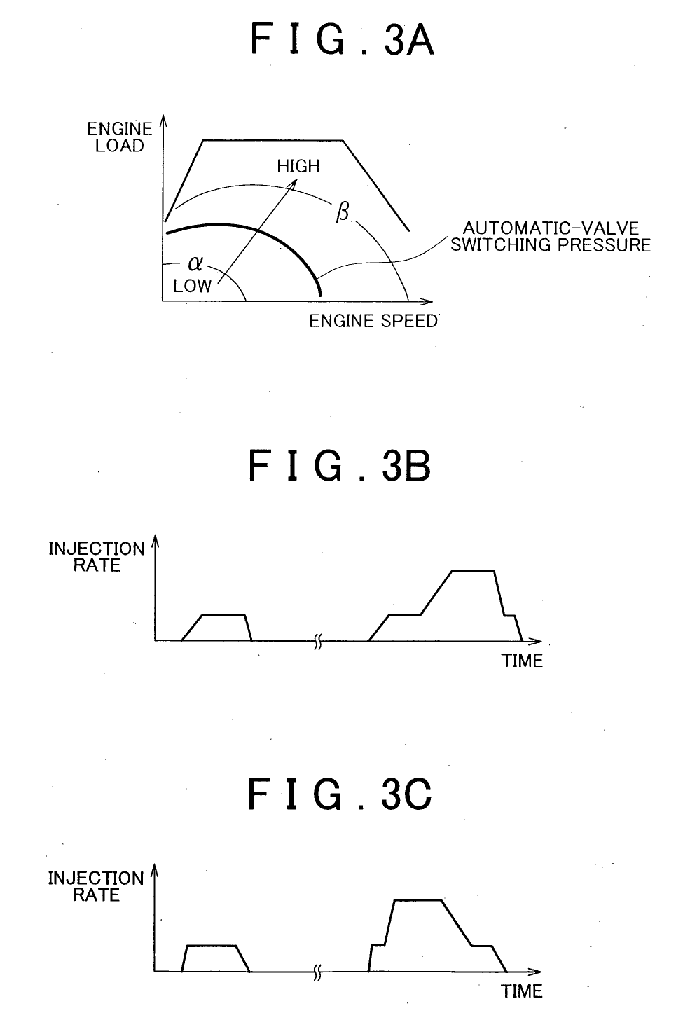

As shown in FIG. 3A, the common-rail pressure in the common rail 1 is changed according to an engine load and an engine speed. That is, when the internal combustion engine is operated in a low-load low-speed state, the pressure in the engine combustion chamber when an engine piston is at the top dead center during a compression stroke (i.e., compression end pressure) is low, and the period of an intake stroke or the compression stroke, during which the fuel needs to be injected, is long. Therefore, the common-rail pressure is set to a low pressure. When the internal combustion engine is operated in a high-load high-speed state, the compression end pressure is high, and the period of the intake stroke or the compression stroke is short. Therefore, the common-rail pressure is set to a high pressure.

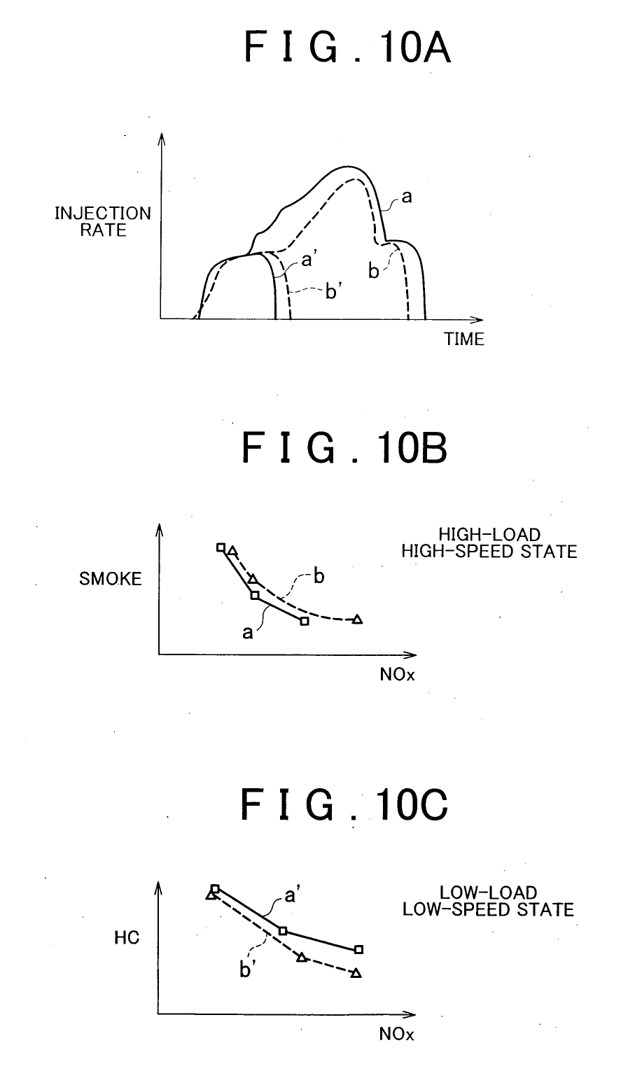

Accordingly, in the embodiment, when the common-rail pressure in the common rail 1 is lower than the predetermined pressure (i.e., an automatic-valve switching pressure in FIG. 3A) (that is, when the point indicating the operating state of the internal combustion engine is in a range cc in FIG. 3A), that is, when the internal combustion engine is operated in the low-load low-speed state, the automatic valve 32 is opened. Therefore, when the state of the control valve 23 is switched to the return passage connection state, the fuel flows out from,the pressure control chamber 20 via the orifice 21 and the fuel outflow/inflow passage 22, and the fuel flows into the pressure control chamber 20 via the fuel inflow passage 31 and the orifice 30. Accordingly, the pressure of the fuel in the pressure control chamber 20 is decreased at a low rate. Thus, as shown in FIG. 3B, an injection rate is increased at a low rate. Because the injection rate is increased at a low rate as shown by the dotted line b′ in FIG. 10C, the amounts of generated HC and NOx are reduced, as compared to when the injection rate is increased at a high rate as shown by the solid line a′ in FIG. 10C.

When the common-rail pressure in the common rail 1 is equal to or higher than the predetermined pressure (that is, when the point indicating the operating state of the internal combustion engine is in a range β in FIG. 3A), that is, when the internal combustion engine is operated in the high-load high-speed state, the automatic valve 32 is closed. Therefore, when the state of the control valve 23 is switched to the return passage connection state, and therefore, the fuel flows out from the pressure control chamber 20 via the orifice 21 and the fuel outflow/inflow passage 22, the fuel does not flow into the pressure control chamber 20 via the flow passage 31 and the orifice 30. Accordingly, the pressure of the fuel in the pressure control chamber 20 is decreased at a high rate. Thus, as shown in FIG. 3C, the injection rate is increased at a high rate. As a result, the speed at which the fuel injected is increased, and thus, the output from the internal combustion engine is increased. In addition, because the injection rate is increased at a high rate as shown by the solid line a in FIG. 10B, the amounts of generated smoke and NOx are reduced, as compared to when the injection rate is increased at a low rate as shown by the dotted line b in FIG. 10B.

That is, with the fuel injection valve 2 in the embodiment, when the internal combustion engine is operated in the low-load low-speed state, the amounts of generated HC and NOx are reduced. When the internal combustion engine is operated in the high-load high-speed state, the amounts of generated smoke and NOx are reduced, and the output from the internal combustion engine is increased.

In the embodiment, the automatic valve 32 is used as a switching valve that opens and closes the fuel inflow passage 31 according to the common-rail pressure. However, the automatic valve 32 may be a flow rate control valve whose opening degree is changed according to the common-rail pressure, and which controls the flow rate at which the fuel flows in the fuel inflow passage 31.

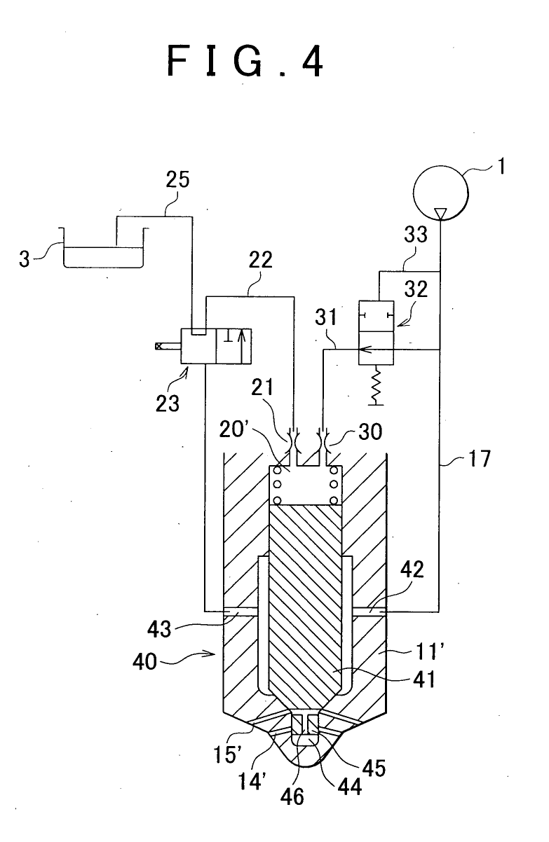

FIG. 4 shows a fuel injection valve according to a modified example of the first embodiment. As shown in FIG. 4, the fuel injection valve 40 in the modified example includes two injection hole groups 14′ and 15′, as well as the fuel injection valve 2 in the above-described embodiment. However, the fuel injection valve 40 in the modified example includes only one needle valve 41. A nozzle body 11′ includes an inflow through hole 42, and an outflow through hole 43 formed on the side portions of the nozzle body 11′. The inflow through hole 42 is communicated with the high-pressure fuel supply passage 17. The outflow through hole 43 is communicated with the control valve 23. A sac portion 44 is provided in the end of nozzle body 11′. The inner injection hole group 14′ is communicated with the sac portion 44. A cylindrical portion 45 is provided in the end of the needle valve 41. The cylindrical portion 45 slides in the sac portion 44. A T-shaped passage 46 is provided in the cylindrical portion 45.

In the fuel injection valve 40 shown in FIG. 4, when the pressure of the fuel in a pressure control chamber 20′ is high, the needle valve 41 is not lifted, and thus, all the injection holes in the outer injection hole group 15′ and the inner injection hole group 14′ are closed by the needle valve 41. In this situation, when the pressure of the fuel in the pressure control chamber 20′ is decreased, the needle valve 41 starts to be lifted. When the needle valve 41 starts to be lifted, the injection holes in the outer injection hole group 15′ are opened, and the fuel starts to be injected from the injection holes in the outer injection hole group 15′. At this time, the injection holes in the inner injection hole group 14′ are closed by the cylindrical portion 45 of the needle valve 41, and accordingly, no fuel is injected from the injection holes in the inner injection hole group 14′.

Then, when the pressure of the fuel in the pressure control chamber 20′ is further decreased, and thus the needle valve 41 is further lifted, the amount of fuel injected from the injection holes in the outer injection hole group 15′ is increased. In addition, the injection holes in the inner injection hole group 14′ are opened, and the fuel starts to be injected from the injection holes in the inner injection hole group 14′. Then, when the pressure of the fuel in the pressure control chamber 20′ is further decreased, the amount of fuel injected from the injection holes in the inner injection hole group 14′ is increased.

In the modified example, the orifice 21, the fuel outflow/inflow passage 22, the control valve 23, the orifice 30, the fuel inflow passage 31, the automatic valve 32, and the automatic valve drive fuel passage 33 are provided, as in the fuel injection valve 2 in the first embodiment. Thus, the rate, at which the pressure of the fuel in the pressure control chamber 20′ is decreased, is changed according to the common-rail pressure. When the common-rail pressure is low, the pressure of the fuel in the pressure control chamber 20′ is decreased at a low rate. When the common-rail pressure is high, the pressure of the fuel in the pressure control chamber 20′ is decreased at a high rate. As a result, as in the first embodiment, when the internal combustion engine is operated in the low-load low-speed state, the amounts of generated HC and NOx are reduced. In addition, when the internal combustion engine is operated in the high-load high-speed state, the amounts of generated smoke and NOx are reduced, and the output from the internal combustion engine is increased.

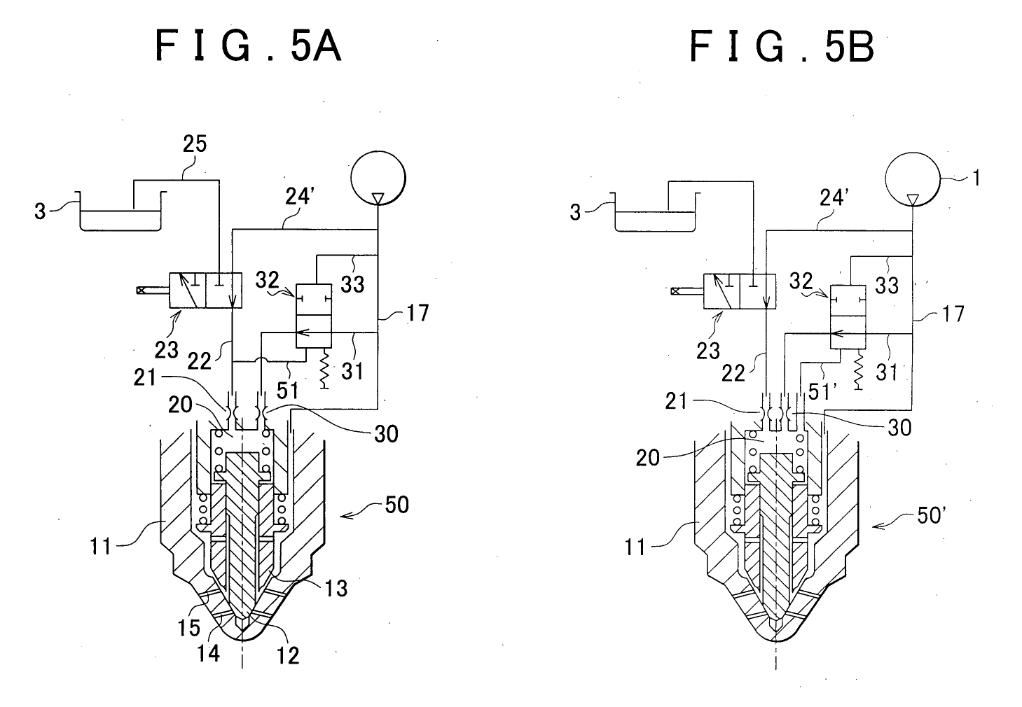

Next, a fuel injection valve 50 according to a second embodiment will be described with reference to FIG. 5A. The fuel injection valve 50 according to the second embodiment has the same basic configuration as that of the fuel injection valve 2 according to the first embodiment.

However, in the fuel injection valve 50, the control valve 23 is connected to a high-pressure fuel passage 24′ that is communicated with the common rail 1, instead of the high-pressure fuel passage 24 that is communicated with the nozzle chamber 16. In addition, the automatic valve 32 is connected to the automatic valve drive fuel passage 33 and an automatic valve control fuel passage 51, and the automatic valve control fuel passage 51 is communicated with the fuel outflow/inflow passage 22. The automatic valve 32 is operated according to a difference between the pressure of the fuel in the automatic valve drive fuel passage 33 and the pressure of the fuel in the automatic valve control fuel passage 51 (hereinafter, the difference will be referred to as “fuel pressure difference”). When the fuel pressure difference is small, the automatic valve 32 is opened. When the fuel pressure difference is large, the automatic valve 32 is closed.

The pressure of the fuel in the automatic valve control fuel passage 51 is changed according to the pressure of the fuel flowing in the fuel outflow/inflow passage 22. Therefore, when the control valve 23 is in the high-pressure passage connection state, that is, when the high-pressure fuel flows in the fuel outflow/inflow passage 22, the pressure of the fuel in the automatic valve control fuel passage 51 is also high. When the control valve 23 is in the return passage connection state, and the pressure of the fuel flowing in the fuel outflow/inflow passage 22 is gradually decreased, the pressure of the fuel in the automatic valve control fuel passage 51 is also gradually decreased.

Accordingly, when the control valve 23 is in the high-pressure passage connection state, the fuel pressure difference is substantially zero, and therefore, the automatic valve 32 is opened as shown in FIG. 5A. Thus, the fuel flows into the pressure control chamber 20 via the fuel outflow/inflow passage 22 and the fuel inflow passage 31. As a result, the pressure in the pressure control chamber 20 remains equal to the common-rail pressure. Therefore, the needle valves 12 and 13 are not lifted, and accordingly, no fuel is injected from the injection holes in both of the injection hole groups 14 and 15.

Then, when the state of the control valve 23 is switched to the return passage connection state, the fuel flows out from the pressure control chamber 20 via the fuel outflow/inflow passage 22 and the return passage 25. Thus, the pressure of the fuel in the pressure control chamber 20 is decreased, and the outer needle valve 13 starts to be lifted. As a result, the fuel is injected from the injection holes in the outer injection hole group 15. However, because the automatic valve 23 is open immediately after the state of the control valve 23 is switched to the return passage connection state, the fuel flows into the pressure control chamber 20 via the fuel inflow passage 31, and therefore, the pressure of the fuel in the pressure control chamber 20 is decreased at a low rate. As a result, the outer needle valve 13 is lifted at a low speed.

Then, when the pressure of the fuel in the pressure control chamber 20 is lower than a predetermined pressure, the inner needle valve 12 is also lifted, as well as the outer needle valve 13. As a result, the fuel is injected also from the injection holes in the inner injection hole group 14. Also, the fuel pressure difference becomes equal to or larger than a predetermined pressure difference around the timing at which the pressure of the fuel in the pressure control chamber 20 becomes lower than the predetermined pressure. Accordingly, the automatic valve 32 is closed, and thus, the fuel does not flow into the pressure control chamber 20 via the fuel inflow passage 31. This increases the flow rate at which the fuel flows out from the pressure control chamber 20, and accordingly, increases the speed at which the outer needle valve 13 is lifted, or the speed at which both of the needle valves 12 and 13 are lifted.

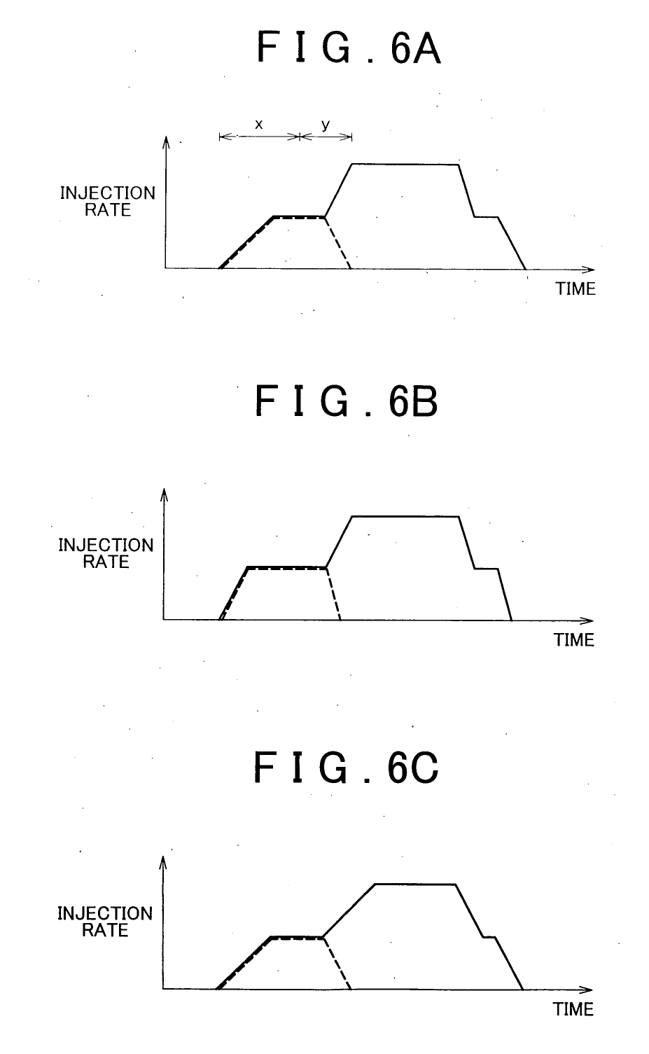

Each of FIGS. 6A, 6B, and 6C shows a change in the injection rate during a period from when fuel injection from the fuel injection valve is started, until when the fuel injection is finished. More specifically, FIG. 6A shows a change in the injection rate at which the fuel is injected from the fuel injection valve 50 according to the embodiment, in the case where the state of the automatic valve 32 is switched from the open state to the closed state after the lifting of the outer needle valve 13 is finished, and before the lifting of the inner needle valve 12 is started. Each of FIG. 6B and FIB. 6C shows a change in the injection rate during the period from when fuel injection from a fuel injection valve is started, until when the fuel injection is finished, in the case where the fuel inflow passage 31 and the like are not provided in the fuel injection valve. More specifically, FIG. 6B shows the case where the opening degree of the orifice 21 provided in the fuel outflow/inflow passage 22 is large, and accordingly, the fuel flows out from the pressure control chamber 20 at a high flow rate. FIG. 6C shows the case where the opening degree of the orifice 21 is small, and accordingly, the fuel flows out from the pressure control chamber 20 at a low flow rate.

As shown in FIG. 6A, in the fuel injection valve 50 according to the embodiment, in an early part (i.e., the period x in FIG. 6A) of the period in which the needle valves 12 and 13 are lifted after the start of the fuel injection, the pressure of the fuel in the pressure control chamber 20 is decreased at a low rate, and therefore, the injection rate is increased at a low rate. During a late part (i.e., the period y in FIG. 6A) of the period in which the needle valves 12 and 13 are lifted, the pressure of the fuel in the pressure control chamber 20 is decreased at a high rate, and therefore, the injection rate is increased at a high rate.

The injection rate, at which the fuel is injected from the fuel injection valve 50 according to the embodiment, is changed in the above-described manner. Therefore, when the internal combustion engine is operated in the low-load low-speed state, the fuel is injected from the fuel injection valve 50 in the manner shown by the dashed line in FIG. 6A. Because the fuel is injected in the manner shown by the dashed line in FIG. 6A, the injection rate is increased at a low rate, and therefore, the amounts of generated HC and NOx are reduced as shown in FIG. 10C.

When the internal combustion engine is operated in the high-load high-speed state, the fuel is injected from the fuel injection valve 50 in the manner shown by the solid line in FIG. 6A. Because the fuel is injected in the manner shown by the solid line in FIG. 6A, the injection rate is increased at a high rate during at least the late part of the period in which the needle valves 12 and 13 are lifted, and therefore, a large amount of fuel is injected in a short time, and the output from the internal combustion engine is increased. In addition, the amounts of generated smoke and NOx are reduced as shown in FIG. 10B.

That is, with the above-described fuel injection valve 50, when the internal combustion engine is operated in the low-load low-speed state, the amounts of generated HC and NOx are reduced. In addition, when the internal combustion engine is operated in the high-load high-speed state, the amounts of smoke and NOx are reduced, and the output from the internal combustion engine is increased.

Thus, in the embodiment, when the fuel is injected from the fuel injection valve 50, the rate, at which the pressure of the fuel in the fuel control chamber 20 is decreased, is changed between two levels according to the lifting of the needle valves 12 and 13. Therefore, the fuel injection pattern is appropriately changed according to a fuel injection amount, that is, an engine load.

The condition for switching the state of the automatic valve 32 is changed according to the common-rail pressure. That is, as the common-rail pressure becomes higher, the pressure of the fuel in the fuel outflow/inflow passage 22, at which the state of the automatic valve 32 is switched from the open state to the closed state, becomes higher.

It is preferable that the predetermined pressure and the predetermined pressure difference should be set so that the fuel pressure difference becomes equal to or larger than the predetermined pressure difference at the same timing as the timing at which the pressure of the fuel in the pressure control chamber 20 becomes lower than the predetermined pressure. However, the predetermined pressure and the predetermined pressure difference may be set so that the fuel pressure difference becomes equal to or larger than the predetermined pressure difference before or after the pressure of the fuel in the pressure control chamber 20 becomes lower than the predetermined pressure.

FIG. 5B shows a fuel injection valve 50′ according to a modified example of the second embodiment, that is, the fuel injection valve 50′ formed by modifying the fuel injection valve 50 according to the second embodiment. The fuel injection valve 50′ according to the modified example has the same basic configuration as that of the fuel injection valve 50 according to the second embodiment. However, the fuel injection valve 50′ differs from the fuel injection valve 50 in that an automatic valve control fuel passage 51′ is connected to the pressure control chamber 20, and is not connected to the fuel outflow/inflow passage 22.

When the control valve 23 is in the return passage connection state, the pressure of the fuel in the pressure control chamber 20 is decreased at a lower rate than the rate at which the pressure of the fuel in the fuel outflow/inflow passage 22 is decreased, due to the effect of the orifice. Accordingly, in the fuel injection valve 50′ in the modified example, switching of the state of the automatic valve 32 to the closed state is delayed, as compared to the fuel injection valve 50 in the second embodiment.

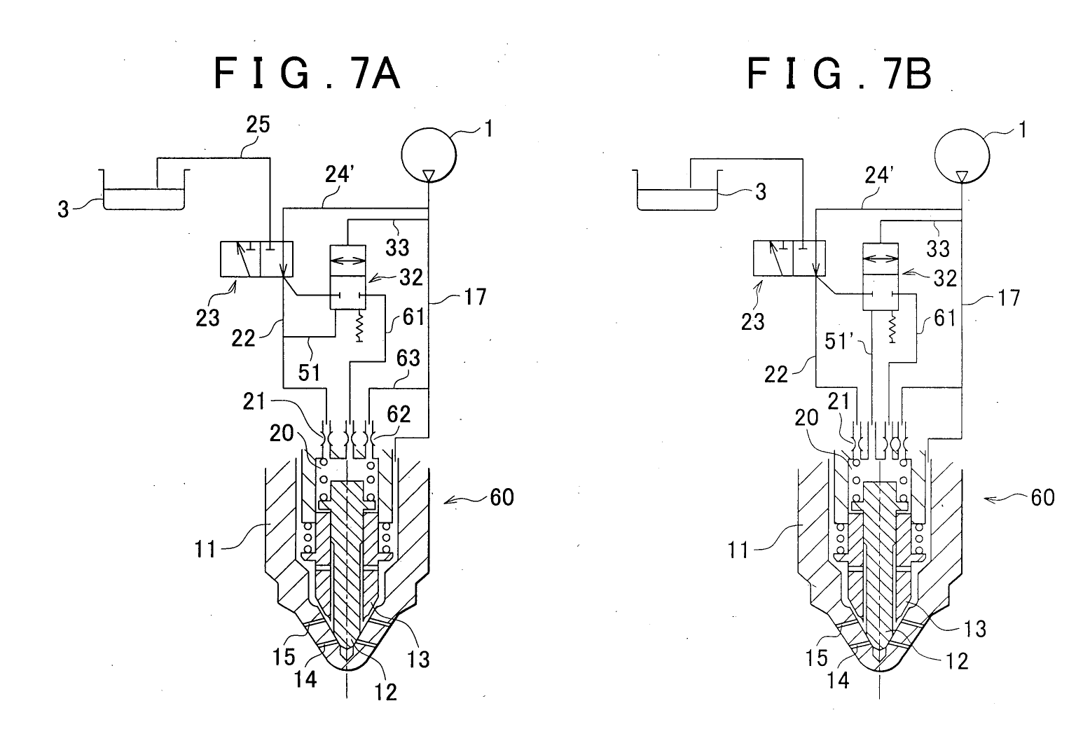

Next, a fuel injection valve 60 according to a third embodiment of the invention will be described with reference to FIG. 7A. The fuel injection valve 60 according to the third embodiment has the same basic configuration as that of the fuel injection valve 50 according to the second embodiment.

However, in the fuel injection valve 60, the control valve 23 is connected to the fuel outflow/inflow passage 22, a fuel outflow/inflow passage 61, the high-pressure fuel passage 24′, and the return passage 25. The two fuel outflow/inflow passages 22 and 61 are communicated with the pressure control chamber 20. The high-pressure fuel passage 24′ is communicated with the common rail 1. The return passage 25 is connected to the fuel tank 3. The state of the control valve 23 is switched between a state where the fuel outflow/inflow passages 22 and 61 are connected to the high-pressure fuel passage 24′ (i.e., the high-pressure passage connection state), and a state where the fuel outflow/inflow passages 22 and 61 are connected to the return passage 25 (i.e., the return passage connection state).

The automatic valve 32 is provided in the fuel outflow/inflow passage 61. The automatic valve 32 is connected to the automatic valve drive fuel passage 33 and the automatic valve control fuel passage 51. The automatic valve control fuel passage 51 is connected to the fuel outflow/inflow passage 22. The automatic valve 32 is operated according to the difference between the pressure of the fuel in the automatic valve drive fuel passage 33 and the pressure of the fuel in the automatic valve control fuel passage 51. When the fuel pressure difference is small, the automatic valve 32 is closed. When the fuel pressure difference is large, the automatic valve 32 is opened.

The pressure of the fuel in the automatic valve control fuel passage 51 is changed according to the pressure of the fuel flowing in the fuel outflow/inflow passage 22. Therefore, when the control valve 23 is in the high-pressure passage connection state, the pressure of the fuel in the automatic valve control fuel passage 51 is high. When the control valve 23 is in the return passage connection state, the pressure of the fuel in the automatic valve control fuel passage 51 is gradually decreased.

Accordingly, when the control valve 23 is in the high-pressure passage connection state, the fuel pressure difference is substantially zero, and therefore, the automatic valve 32 is closed as shown in FIG. 7A. Thus, the fuel flows into the pressure control chamber 20 via the high-pressure fuel passage 24′ and the fuel outflow/inflow passage 22, and the pressure in the pressure control chamber 20 remains equal to the common-rail pressure. Therefore, the needle valves 12 and 13 are not lifted, and no fuel is injected from the injection holes in both of the injection hole groups 14 and 15.

Then, when the control valve 23 is placed in the return passage connection state, the fuel flows out from the pressure control chamber 20 via only one fuel outflow/inflow passage 22, because the automatic valve 32 is closed. Accordingly, the outer needle valve 13 is lifted, and thus, the fuel is injected from the injection holes in the outer injection hole group 15. Also, because the pressure of the fuel outflow/inflow passage 22 and the pressure of the fuel in the automatic valve control fuel passage 51 are decreased, the fuel pressure difference is gradually increased.

Then, when the pressure of the fuel in the pressure control chamber 20 is lower than a predetermined pressure, the inner needle valve 12 is also lifted, as well as the outer needle valve 13. As a result, the fuel is injected also from the injection holes in the inner injection hole group 14. Also, the fuel pressure difference becomes equal to or larger than the predetermined pressure difference around the timing at which the pressure of the fuel in the pressure control chamber 20 becomes lower than the predetermined pressure. Accordingly, the automatic valve 32 is opened, and thus, the fuel flows out from the pressure control chamber 20 via both of the fuel outflow/inflow passages 21 and 61. This increases the rate at which the fuel flows out from the pressure control chamber 20, and accordingly, increases the speed at which the outer needle valve is lifted, or the speed at which both of the needle valves 12 and 13 are lifted.

Thus, according to the embodiment, when the fuel is injected from the fuel injection valve 60, the rate, at which the pressure of the fuel in the pressure control chamber 20 is decreased, is changed between two levels according to the lifting of the needle valves 12 and 13. Therefore, the fuel injection pattern is appropriately changed according to the fuel injection amount, that is, the engine load.

The condition for switching the state of the automatic valve 32 is changed according to the common-rail pressure. That is, as the common-rail pressure becomes higher, the pressure of the fuel in the fuel outflow/inflow passage 22, at which the state of the automatic valve 32 is switched from the closed state to the open state, becomes higher.

It is preferable that the predetermined pressure and the predetermined pressure difference should be set so that the fuel pressure difference becomes equal to or larger than the predetermined pressure difference at the same timing as the timing at which the pressure of the fuel in the pressure control chamber 20 becomes lower than the predetermined pressure. However, the predetermined pressure and the predetermined pressure difference may be set so that the fuel pressure difference becomes equal to or larger than the predetermined pressure difference before or after the pressure of the fuel in the pressure control chamber 20 becomes lower than the predetermined pressure.

Further, in the embodiment, the high-pressure fuel passage 17 is connected to the pressure control chamber 20 by the orifice 62 and a fuel passage 63. Thus, it is possible to adjust the rate at which the pressure of the fuel in the pressure control chamber 20 is decreased. However, the orifice 62 and the fuel passage 63 do not necessarily need to be provided.

FIG. 7B shows a fuel injection valve 60′ according to a modified example of the third embodiment, that is, the fuel injection valve 60′ formed by modifying the fuel injection valve 60 according to the third embodiment. The fuel injection valve 60′ according to the modified example has the same basic configuration as that of the fuel injection valve 60 according to the third embodiment. However, the fuel injection valve 60′ differs from the fuel injection valve 60 in that the automatic valve control fuel passage 51′ is connected to the pressure control chamber 20, and is not connected to the fuel outflow/inflow passage 22. Therefore, in the modified example, no orifice is provided in the automatic valve control fuel passage 51′, and the orifice 21 is provided in the fuel outflow/inflow passage 22. Accordingly, in the fuel injection valve 60′ in the modified example, switching of the state of the automatic valve 32 to the open state is delayed, as compared to the fuel injection valve 60 in the second embodiment.

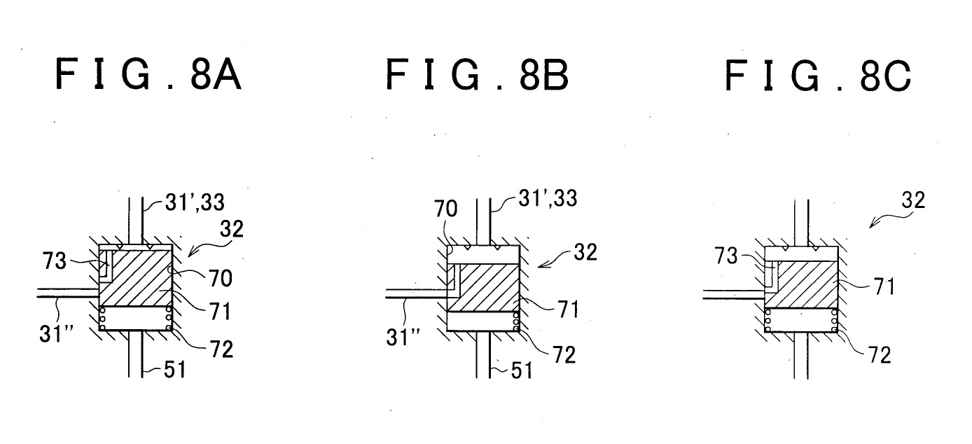

FIGS. 8A, 8B, and 8C show an example of the configuration of the automatic valve 32 used in the fuel injection valve 50 according to the second embodiment, the fuel injection valve 60 according to the third embodiment, and the like. The automatic valve 32 shown in FIGS. 8A, 8B, and 8C is used particularly in the fuel injection valve 50 according to the second embodiment. As shown in FIGS. 8A, 8B, and 8C, the automatic valve 32 includes a cylinder 70, a piston 71 that slides in the cylinder 70, and a spring 72 that presses the piston 71. The cylinder 70 is connected to three passages. A passage, which is formed by combining an upstream fuel inflow passage 31′ leading to the fuel injection valve 50 or 60 and the automatic valve drive fuel passage 33, is connected to an end surface (first surface) of the cylinder 70 in a direction in which the piston 71 slides. The automatic valve control fuel passage 51 is connected to another end surface (second surface) of the cylinder 70 in the direction in which the piston 71 slides. A downstream fuel inflow passage 31″ is connected to the side surface of the cylinder 70. Note that the fuel inflow passage 31 includes the upstream fuel inflow passage 31′ upstream of the automatic valve 32, and the downstream fuel inflow passage 31″ downstream of the automatic valve 32. In the piston 71, a passage 73 is provided. The passage 73 connects the one end surface (the upper surface in each of FIGS. 8A, 8B, and 8C) to the side surface.

In the automatic valve 32 with the above-described configuration, when the pressure of the fuel in the automatic valve control fuel passage 51 is high, a difference between the fuel pressure applied to the upper surface of the piston 71 and the fuel pressure applied to the lower surface of the piston 71 is small, and therefore, the spring 72 presses the piston 71 upward, as shown in FIG. 8A. Thus, the outlet of the passage 73 is closed by the wall surface of the cylinder 70, and the fuel inflow passage 31 is closed.

When the pressure of the fuel in the automatic valve control fuel passage 51 is low, the fuel pressure applied to the lower surface of the piston 71 is lower than the fuel pressure applied to the upper surface of the piston 71, and therefore, the piston 71 is moved downward against the pressing force of the spring 72, as shown in FIG. 8B. Thus, the outlet of the passage 73 is communicated with the downstream fuel inflow passage 31″, and accordingly, the fuel inflow passage 31 is opened.

In the automatic valve 32 shown in FIGS. 8A, 8B, and 8C, the diameter or the like of the passage 73 that has a circular cross section may be appropriately set so that when the pressure of the fuel in the automatic valve control fuel passage 51 is not sufficiently low, the outlet of the passage 73 is incompletely opened as shown in FIG. 8C, and accordingly, a small amount of fuel flows into the downstream fuel inflow passage 31″ as compared to when the outlet of the passage 73 is completely opened. In this case, for example, in the fuel injection valve 50 shown in FIG. 5A or the fuel injection valve 50′ shown in FIG. 5B, as the common-rail pressure applied to the upper surface of the piston 71 becomes higher, and as the fuel pressure applied to the lower surface of the piston 71 becomes lower, the opening degree of the outlet of the passage 73 becomes larger, and accordingly, the needle valves 12 and 13 are lifted at a higher speed.

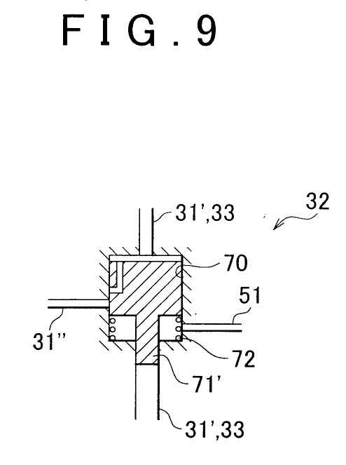

FIG. 9 shows another example of the configuration of the automatic valve 32 used in the fuel injection valve 50 according to the second embodiment, and the fuel injection valve 60 according to the third embodiment. In the automatic valve 32 shown in FIG. 9, the common-rail pressure is applied to a portion of the lower surface of a piston 71′. In the automatic valve 32 shown in FIGS. 8A, 8B, and 8C, the spring 72 needs to have a large pressing force, and a relatively large size to resist the common-rail pressure applied to the upper surface of the piston 71. In contrast, in the automatic valve 32 shown in FIG. 9, the spring 72 does not need to have a large pressing force to resist the common-rail pressure applied to the upper surface of the piston 71′. Accordingly, the spring 72 may have a small size.

1-15. (canceled)

16. A fuel injection valve comprising:
a first injection hole group;
a second injection hole group;
a control chamber;
a needle valve; and
a flow rate change device that changes a flow rate at which fuel flows into the control chamber, or a flow rate at which the fuel flows out from the control chamber, wherein:
an injection hole in the first injection hole group and an injection hole in the second injection hole group are separately opened/closed, according to a lift amount of the needle valve;
the flow rate change device changes the flow rate based on a common-rail pressure in a fuel supply source;
the flow rate change device changes the flow rate so that as the common-rail pressure in the fuel supply source becomes lower, an amount of fuel in the control chamber is decreased at a lower rate; and
the flow rate change device changes the flow rate so that as the common-rail pressure in the fuel supply source becomes higher, an amount of fuel in the control chamber is decreased at a higher rate.

17. The fuel injection valve according to claim 16, wherein
the needle valve includes a first needle valve and a second needle valve;
the first needle valve opens/closes the injection hole in the first injection hole group, and the second needle valve opens/closes the injection hole in the second injection hole; and
lifting of the first needle valve and lifting of the second needle valve are controlled by a pressure of the fuel in the control chamber.

18. The fuel injection valve according to claim 16, wherein
when the lift amount of the needle valve is equal to or smaller than a predetermined amount, only the injection hole in the first injection hole group is opened; and
when the lift amount of the needle valve is larger than the predetermined amount, the injection hole in the first injection hole group and the injection hole in the second injection hole group are opened.

19. The fuel injection valve according to claim 16, wherein:
the flow rate change device includes a fuel inflow passage that is communicated with the fuel supply source and the control chamber, and a flow rate control valve that adjusts a flow rate at which the fuel flows through the fuel inflow passage;
when the common-rail pressure in the fuel supply source is equal to or higher than a predetermined pressure, the flow rate control valve closes the fuel inflow passage; and
when the common-rail pressure is lower than the predetermined pressure, the flow rate control valve completely opens the fuel inflow passage.

20. The fuel injection valve according to claim 19, wherein
an orifice is provided in the fuel inflow passage at a position between the flow rate control valve and the control chamber.

21. The fuel injection valve according to claim 19, wherein
an orifice is provided in a fuel outflow passage through which the fuel flows from the control chamber to a fuel recovery portion.

22. The fuel injection valve according to claim 16, wherein
the flow rate change device changes the flow rate so that in an early part of a period in which the needle valve is lifted, an amount of fuel in the control chamber is decreased at a lower rate than a rate at which the amount of fuel in the control chamber is decreased in a late part of the period in which the needle valve is lifted.

23. The fuel injection valve according to claim 22, wherein:
the flow rate change device includes a fuel inflow passage that is communicated with the fuel supply source and the control chamber, and a flow rate control valve that adjusts a flow rate at which the fuel flows through the fuel inflow passage;
the flow rate control valve closes the fuel inflow passage in the early part of the period in which the needle valve is lifted; and
the flow rate control valve completely opens the fuel inflow passage in the late part of the period in which the needle valve is lifted.

24. The fuel injection, valve according to claim 22, wherein:
the flow rate change device includes a fuel outflow passage that is communicated with a fuel recovery portion and the control chamber, and a flow rate control valve that adjusts a flow rate at which the fuel flows through the fuel outflow passage;
the flow rate control valve closes the fuel outflow passage in the early part of the period in which the needle valve is lifted; and
the flow rate control valve completely opens the fuel outflow passage in the late part of the period in which the needle valve is lifted.

25. The fuel injection valve according to claim 23, wherein:
in the flow rate control valve, a piston is housed in a cylinder to slide in the cylinder;
a first surface of the piston is communicated with the fuel supply source-fl) via an upstream fuel inflow passage;
a second surface of the piston, which is opposite to the first surface, is communicated with the control chamber via a fuel passage for the flow rate control valve; and
a passage is provided in the piston to connect a downstream fuel inflow passage that is communicated with the flow rate control valve, to the first surface.

26. The fuel injection valve according to claim 24, wherein:
in the flow rate control valve a piston is housed in a cylinder to slide in the cylinder;.
a first surface of the piston is communicated with the fuel supply source via an upstream fuel inflow passage;
a second surface of the piston which is opposite to the first surface, is communicated with the control chamber via a fuel passage for the flow rate control valve: and
a passage is provided in the piston to connect a downstream fuel inflow passage that is communicated with the flow rate control valve, to the first surface.
